(19) United States
(12) Patent Application Publication
(10) Pub. No.: US 2026/0089808 A1
(43) Pub. Date: Mar. 26, 2026

(54) PORTABLE ANTI-FOG COSMETIC MIRROR AND ANTI-FOG METHOD

(71) Applicant: Huizhou Hongmi Electronics Co., Ltd., Guangdong (CN)

(72) Inventor: Guibao HUANG, Guangdong (CN)

(21) Appl. No.: 18/932,643

(22) Filed: Oct. 31, 2024

(30) Foreign Application Priority Data
Sep. 23, 2024 (CN) 2024223125890

(51) Int. Cl. H05B 3/84; H05B 1/02

(52) U.S. Cl. CPC H05B 3/845; H05B 1/0252; H05B 2203/003

(57) ABSTRACT

The present invention discloses a portable anti-fog cosmetic mirror and an anti-fog method, where the portable anti-fog cosmetic mirror includes a mirror frame, a heating module, a temperature sensing device and a mirror surface. The heating module is mounted on one side of the mirror surface adjacent to the mirror frame, and includes a heating sheet and a controller; the temperature sensing device is connected to one side of the heating sheet adjacent to the mirror frame and configured to sense an actual temperature of the heating sheet; and the mirror surface is connected to a periphery of the mirror frame. The portable anti-fog cosmetic mirror of the present invention solves the problem that the portable mirror cannot automatically sense the temperature and adjust the heating temperature according to the actual situation, and solves the problem of power consumption of a battery of the portable mirror.

### TECHNICAL FIELD

The present invention relates to the technical field of mirrors, and more particularly to a portable anti-fog cosmetic mirror and an anti-fog method.

### BACKGROUND OF THE INVENTION

Cosmetic mirrors are common daily necessities in life, especially for women. When making up, a relatively clear and bright mirror surface is often needed for observation of how the face looks at any time when making up, so that the face looks more perfect and delicate. However, in seasons such as winter with low temperature, usually, as the temperature is too low, when the mirror encounters hot gases, such as those exhaled from the mouth, or as a result of the temperature of hot water when the mirror is used in a bathroom, due to the temperature difference, there is fogging in the mirror surface, which causes the mirror surface to become blurred, cannot be used smoothly, and often needed to be wiped, and it is a waste of time and troublesome.

In the related art, an automatic temperature control electric heating band is generally provided inside a mirror, and a rotary switch for controlling the automatic temperature control electric heating band is provided outside the mirror, and the automatic temperature control electric heating band is activated by the rotary switch when there is fogging in the mirror to increase the temperature of the mirror, thereby eliminating the fogging from the mirror surface. However, the power requirements of the automatic temperature control electric heating band are high, which cannot be adapted to the use of portable mirrors, and cannot automatically sense the temperature, and adjust the heating temperature according to the real-time air temperature to achieve the effect of energy saving and avoiding scald.

Therefore, it is necessary to solve the problem that the portable mirror cannot automatically sense the temperature and adjust the heating temperature according to the real-time air temperature.

### BRIEF SUMMARY OF THE INVENTION

In order to solve the problems of the prior art, the present invention provides a portable anti-fog cosmetic mirror and an anti-fog method, which solves the problem that the portable mirror cannot automatically sense the temperature and adjust the heating temperature according to the real-time air temperature.

The technical effect to be achieved by the present invention is achieved by:
in a first aspect, the present invention provides a portable anti-fog cosmetic mirror including:
a mirror frame;
a heating module mounted on one side of a mirror surface adjacent to the mirror frame, including a heating sheet and a controller;
a temperature sensing device connected to one side of the heating sheet adjacent to the mirror frame and configured to sense an actual temperature of the heating sheet; and
a mirror surface connected to a periphery of the mirror frame.

In some implementations, the heating sheet is provided with several heating regions.

In the present implementation, the user can control the region where the heat energy is emitted by the heating sheet according to actual requirements, which is more beneficial to save energy consumption.

In some implementations, a surface of the heating sheet is provided with several heating wires, the several heating wires forming a heating surface by meandering, a spacing distance among the several heating wires is any value between 0.5 mm and 10 mm, and the width of the heating wire is any value between 0.5 mm and 10 mm.

In some implementations, the temperature sensing device is a temperature sensor.

In some implementations, a placement region is formed inside the mirror frame, and a mounting region for mounting an LED lighting set is formed between the periphery of the mirror frame and the placement region.

In the present implementation, the LED lighting set is mounted in a mounting region formed between the periphery of the mirror frame and the placement region, and the mounting region plays a limiting role on the LED lighting set, so that the LED lighting set is more fixedly mounted inside the mirror frame, facilitating mounting and at the same time making the overall structure more compact.

In some implementations, a control panel for mounting a temperature control switch and a lighting set switch extends from an edge of the mirror frame.

In some implementations, one side of the control panel is provided with a charging port, and a protection block for snap-fitting the charging port is connected to an edge of the charging port.

In some implementations, a buffer is provided at a junction of the periphery of the mirror frame and the mirror surface.

In the present implementation, when the mirror surface is mounted to the mirror frame, the mirror frame and the mirror surface respectively generate a pressing force on the buffer, so that the connection between the mirror frame and the mirror surface is more tightened, thereby improving the overall structural stability, and avoiding the problem that the mirror is dropped from the mirror frame and cannot be used.

In some implementations, the mirror frame includes a base frame and an annular fixing frame respectively connected to a periphery of the base frame, and one side of the buffer facing away from the base frame to fix the buffer to the base frame.

In some implementations, the mirror frame further includes a bracket assembly including a connector and a support, the connector having one end connected to one side of the mirror frame facing away from the heating sheet by a first pivot and another end connected to the support by a second pivot.

In the present implementation, the support enables the mirror frame to stand on a plane such as a desktop to enable the portable anti-fog cosmetic mirror to stand on a plane such as a desktop, and rotates the connector and/or the mirror frame to rotate the first pivot and/or the second pivot to adjust a rotation angle of the connector and the mirror frame, thereby adjusting a placement angle of the portable anti-fog cosmetic mirror, which is more convenient to use.

In a second aspect, the present invention provides a defogging method for a portable cosmetic mirror, including:
sending, by a controller, a heating signal to control the heating sheet to heat the mirror surface to a maximum pre-set temperature, and then discontinuing heating in response to a defogging start instruction; and
sending a heating signal again to heat the mirror surface when a temperature of the mirror surface is detected to be lower than a first pre-set temperature.

In some implementations, in addition to the sending, by the controller, the heating signal to control the heating sheet to heat the mirror surface to the maximum pre-set temperature, the method further includes:
collecting an actual temperature of the mirror surface;
calculating a temperature difference between the actual temperature and the maximum pre-set temperature; and
adjusting the heating signal according to the temperature difference to control the heating sheet to heat the mirror surface.

In some implementations, after the sending, by the controller, the heating signal to control the heating sheet to heat the mirror surface to the maximum pre-set temperature, and then discontinue heating, the method further includes:
detecting a mirror surface fogging condition, and recording a current temperature of the mirror surface as a fogging temperature through a temperature sensing device after receiving a mirror surface fogging signal;
acquiring, by the controller, a pre-set compensation temperature, and setting a target heating temperature by combining the fogging temperature and the pre-set compensation temperature;
issuing, by the controller, a heating signal to heat the mirror surface when the controller detects that the temperature of the mirror surface is lower than the target heating temperature.

In some implementations, in addition to the sending, by the controller, the heating signal to control heating the mirror surface to the maximum pre-set temperature, the method further includes:
collecting a current temperature of the mirror surface as an initial temperature;
calculating a difference between the maximum pre-set temperature and the initial temperature; and
recording heating time, calculating a heating speed, and updating the heating signal according to the heating speed.

In some implementations, the heating signal includes heating power; and the heating power is inversely related to the heating speed.

In some implementations, the acquiring the pre-set compensation temperature, and setting the target heating temperature by combining the fogging temperature and the pre-set compensation temperature includes the following sub-steps:
acquiring a value of the pre-set compensation temperature and a value of the fogging temperature; and
adding the value of the pre-set compensation temperature and the value of the fogging temperature to obtain the target heating temperature.

In some implementations, the pre-set compensation temperature is any one of 2° C. to 4° C.

In some implementations, the pre-set compensation temperature is inversely related to the heating speed.

In some implementations, the mirror surface fogging signal is a defogging start instruction; the detecting the mirror surface fogging condition, and recording the current temperature of the mirror surface as the fogging temperature after receiving the mirror surface fogging signal includes the following sub-steps:
detecting whether the defogging start instruction is received; and
recording the current temperature of the mirror surface and setting the temperature as the fogging temperature if the defogging start instruction is received.

In some implementations, the detecting whether the defogging start instruction is received further includes:
continuously monitoring the temperature of the mirror surface at pre-set intervals; and
entering a sleep state to discontinue acquiring the temperature of the mirror surface and discontinuing sending the heating signal if the mirror temperature is less than an initial temperature or the continuous monitoring time exceeds a pre-set off time.

In view of the above, the present invention has at least the following advantages:
according to the portable anti-fog cosmetic mirror provided by the present invention, by providing a temperature sensing device and a heating module inside the mirror frame, the temperature sensing device can acquire the temperature of the cosmetic mirror and feedback the temperature to a controller to control the heating sheet to emit heat energy to defog from the mirror surface; when the temperature of the cosmetic mirror reaches a pre-set maximum temperature, the heating sheet discontinues heating, and the problem of scalding of a user due to an excessively high heating temperature is avoided while defogging, and energy consumption is also saved. As such, the problem that the portable mirror cannot automatically sense the temperature and adjust the heating temperature according to the real-time air temperature has been solved.

### BRIEF DESCRIPTION OF THE DRAWINGS

FIG. 1 is a schematic structural diagram showing a portable anti-fog cosmetic mirror in Embodiment 1;

FIG. 2 is a schematic structural diagram showing a heating sheet as shown in FIG. 1;

FIG. 3 is a schematic structural diagram showing a heating wire as shown in FIG. 2;

FIG. 4 is a schematic structural diagram showing a portable anti-fog cosmetic mirror in Embodiment 2;

FIG. 5 is a schematic structural diagram showing a charging port and a protection block as shown in FIG. 4;

FIG. 6 is a schematic structural diagram showing a buffer with a mirror surface and a mirror frame respectively in Embodiment 4;

FIG. 7 is a schematic cross-sectional view of a buffer with a mirror surface and a mirror frame respectively as shown in FIG. 6;

FIG. 8 is a schematic structural diagram showing a buffer with an annular fixing frame and a base frame respectively as shown in FIG. 6;

FIG. 9 is a schematic structural diagram showing a bracket assembly as shown in FIG. 3;

FIG. 10 is a schematic flow chart of an anti-fog method for a portable anti-fog cosmetic mirror in Embodiment 4;

FIG. 11 is a flow chart of steps after step 110 as shown in FIG. 10;

FIG. 12 is a flow chart of sub-steps in step 110 as shown in FIG. 10;

FIG. 13 is a flow chart of sub-steps in step 220 as shown in FIG. 11;

FIG. 14 is a flow chart of sub-steps in step 210 as shown in FIG. 11;

FIG. 15 is a schematic structural diagram showing an anti-fog device of a portable anti-fog cosmetic mirror according to the present invention.

Reference numerals are as follows:
1. mirror frame; 11. placement region; 12. LED lighting set; 13. mounting region; 14. temperature control switch; 15. lighting set switch; 16. control panel; 161. charging port; 162. protection block; 17. buffer; 18. base frame; 19. annular fixing frame;
2. heating module; 21. heating sheet; 211, heating region; 212. heating wire; 22. controller;
3. temperature sensing device;
4. mirror surface;
5. bracket assembly; 51. connector; 52. support; 53. first pivot; 54. second pivot.

### DETAILED DESCRIPTION OF THE INVENTION

In order to make the objects, technical solutions and advantages of the embodiments of the present invention more apparent, the technical solutions of the embodiments of the present invention will be clearly and completely described below with reference to the accompanying drawings. The described embodiments are illustrative of some, but not all embodiments of the present invention.

Thus, the following detailed description of the embodiments of the present invention, as presented in the figures, is not intended to limit the scope of the present invention as claimed, but is merely representative of selected embodiments of the present invention. All other embodiments, which can be obtained by a person skilled in the art without inventive efforts based on the embodiments of the present invention, are within the scope of protection of the present invention.

### Embodiment 1

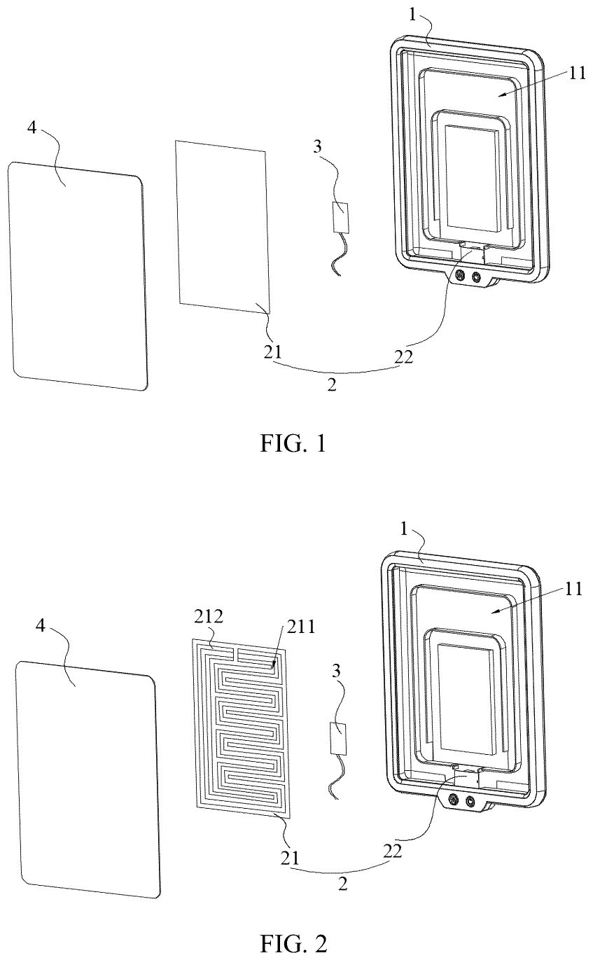

Referring to FIGS. 1 and 2, the portable anti-fog cosmetic mirror of the present invention includes a mirror frame 1, a heating sheet 21, a temperature sensing device 3 and a mirror surface 4.

Referring to FIG. 1, FIG. 1 schematically illustrates a structural relationship among a heating sheet 21, a temperature sensing device 3, and a mirror surface 4, respectively according to an embodiment of the present invention. Specifically, the heating module 2 is mounted on one side of the mirror surface 4 adjacent to the mirror frame 1, and includes a heating sheet 21 and a controller 22; the temperature sensing device 3 is connected to one side of the heating sheet 21 adjacent to the mirror frame 1 for sensing the actual temperature of the heating sheet 21; and the mirror surface 4 is connected to a periphery of the mirror frame 1.

In the present embodiment, the heating module 2 is mounted on one side of the mirror surface 4 adjacent to the mirror frame 1, and the heating module is closely attached to the mirror surface 4 to better conduct heat, and at the same time, the overall structure is more compact, and the space occupied is reduced to make the cosmetic mirror lighter and thinner, thus ensuring the portability of the cosmetic mirror; the heating sheet 21 is used to heat the cosmetic mirror to defog, the controller 22 is used to perform an anti-fog method, and the temperature sensing device 3 is used to sense the temperature of the mirror surface 4. When the defogging instruction is initiated, the controller 22 controls the heating sheet 21 to emit thermal energy to increase the temperature of the cosmetic mirror, thereby eliminating the hot air exhaled by the human body and making the mirror surface 4 generate fog under the effect of temperature difference to achieve the defogging effect and ensure the clarity of the mirror surface 4. Preferably, after acquiring the temperature of the mirror surface 4, the temperature sensing device 3 feeds back the temperature to the controller 22; the controller 22 can match a pre-set heating power according to the temperature of the mirror surface 4, and control the heating sheet 21 to emit thermal energy; during the heating process, the temperature sensing device 3 continuously acquires the temperature of the mirror surface 4 and/or the heating sheet 21; when the temperature of the mirror surface 4 and/or the heating sheet 21 reaches a pre-set maximum temperature, it is determined that the defogging is completed; and the controller 22 controls the heating sheet 21 to discontinue heating, while avoiding excessive energy consumption when the defogging is completed. Of course, it is also possible to control the heating sheet 21 to emit thermal energy by means of human operation, and turn off the heating function of the heating sheet 21 after removing the fog from the mirror surface 4 to achieve the effects of defogging and saving energy.

According to the portable anti-fog cosmetic mirror, by providing a temperature sensing device 3 and a heating module 2 inside the mirror frame 1, the temperature sensing device 3 can acquire the temperature of the cosmetic mirror and feedback the temperature to a controller 22 to control the heating sheet 21 to emit heat energy to defog from the mirror surface 4; when the temperature of the cosmetic mirror reaches a pre-set maximum temperature, the heating sheet 21 discontinues heating, and the problem of scalding of a user due to an excessively high heating temperature is avoided while defogging, and energy consumption is also saved. Thus, the problem that the portable mirror cannot automatically sense the temperature and adjust the heating temperature according to the actual situation is solved.

In some preferred embodiments, referring to FIG. 2, FIG. 2 illustrates a specific structure of the heating sheet 21 in an embodiment of the present invention. Specifically, the heating sheet 21 is provided with several heating regions 211. The user can control the region where the heat energy is emitted by the heating sheet 21 according to actual requirements, which is more beneficial to save energy consumption. It can be understood that when the gas exhaled by the human body produces a small-range fogging effect on the mirror surface 4, a defogging effect can be exerted for the small-range fog by adjusting the heating region 211 of the heating sheet 21 to ensure the clarity of the mirror surface 4 while achieving the effect of reducing energy consumption.

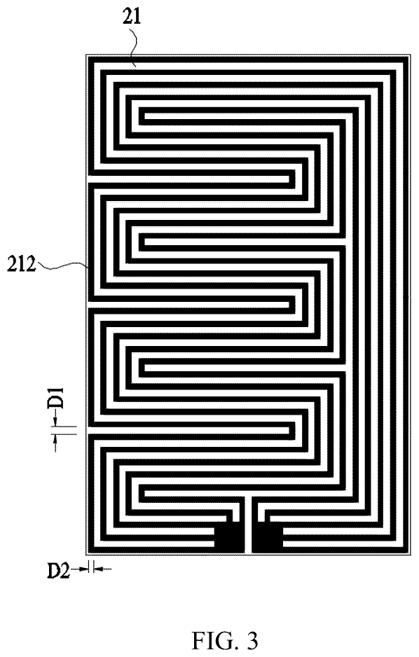

In some preferred embodiments, referring to FIG. 3, the surface of the heating sheet 21 has several heating wires 212, and several heating wires 212 form a heating surface by meandering, a spacing distance D1 among several heating wires 212 is preferably any value between 0.5 mm and 10 mm, and the width D2 of the heating wires 212 is preferably any value between 0.5 mm and 10 mm. The heating wires 212 are uniformly spaced on the heating sheet 21 to make the heating temperature of the heating sheet 21 more uniform, thereby improving the heating effect of the heating sheet 21. Further, the thermal energy generated between the heating wires 212 and the heating wires 212 can generate a stronger heating effect under interaction, and since the heating wires 212 are arranged on the heating sheet 21 at intervals, the defogging effect can be achieved without heating the entire heating sheet 21, thereby saving energy consumption. The meandering way enables the heating wires 212 to be uniformly distributed on the heating sheet 21 to avoid a dead angle, resulting in uneven heating and thus affecting the defogging effect. Preferably, several heating wires 212 may form a heating surface by serpentine, circular, curved, regular and/or irregular winding.

In some more preferred embodiments, the temperature sensing device 3 is a temperature sensor. It is used for acquiring the temperature of the cosmetic mirror in real time, and controlling the heating sheet 21 to emit thermal energy to achieve a defogging effect. Moreover, it is easy to mount and/or disassemble, improving mounting and maintenance efficiency; the temporary space is small, which further ensures the portability of the cosmetic mirror.

### Embodiment 2

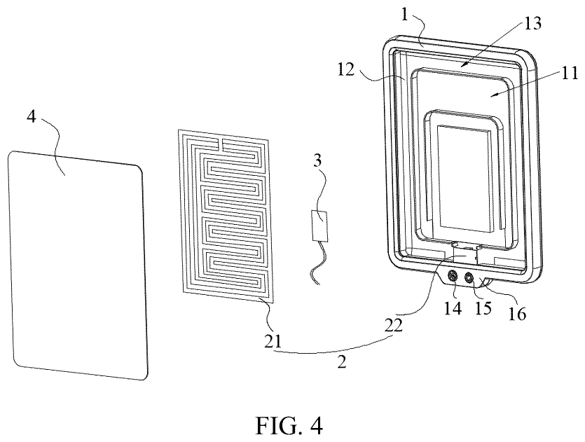

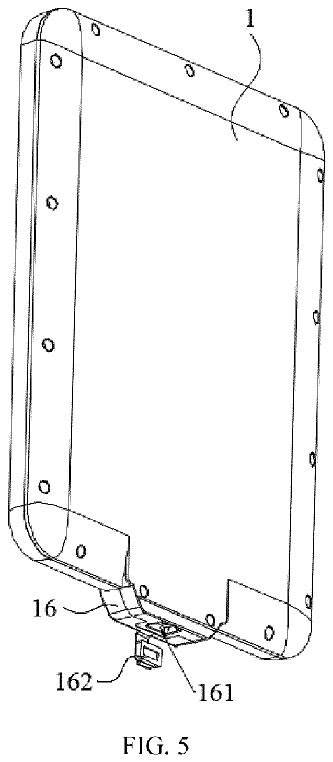

The present embodiment differs from Embodiment 1 in that the present embodiment further optimizes the structure of the portable anti-fog cosmetic mirror of the present invention, see FIGS. 4 and 5.

Referring to FIG. 4, FIG. 4 illustrates a structural relationship between the LED lighting set 12 and the mirror frame 1 in an embodiment of the present invention. Specifically, a placement region 11 is formed inside the mirror frame 1, and a mounting region 13 for mounting an LED lighting set 12 is formed between the periphery of the mirror frame 1 and the placement region 11.

In the present embodiment, the LED lighting set 12 is mounted in a mounting region 13 formed between the periphery of the mirror frame 1 and the placement region 11, and the mounting region 13 plays the role of limiting the LED lighting set 12, so that the LED lighting set 12 is more fixedly mounted inside the mirror frame 1, facilitating mounting and at the same time making the overall structure more compact; furthermore, the problem of interference between the heating sheet 21 and the LED lighting set 12, thereby affecting the normal operation of the heating sheet 21 and/or the LED lighting set 12, is avoided.

In some preferred embodiments, the LED lighting set 12 is a three-color lamp. A user may further adapt to different usage scenarios by controlling the LED lighting set 12 such that the LED lighting set 12 emits light of different colors. It will be appreciated that in dim scenarios, a warm yellow flexible light may be used to achieve a lighting effect in order not to disturb others.

In some preferred embodiments, referring to FIG. 5, FIG. 5 illustrates a structural relationship among the temperature control switch 14, the lighting set switch 15, and the control panel 16, respectively, in an embodiment of the present invention. Specifically, a control panel 16 for mounting a temperature control switch 14 and a lighting set switch 15 extends from an edge of the mirror frame 1. A user can make the heating sheet 21 start emitting heat energy and/or turn off the heating function of the heating sheet 21 by operating the temperature control switch 14; the LED lighting set 12 may be turned off by operating the lighting set switch 15 to cause the LED lighting set 12 to emit light. It can be understood that by operating the temperature control switch 14, it is also possible to adjust the heating temperature and/or heating region of the heating sheet 21 according to the actual defogging demand to defog; by operating the lighting set switch 15, the light color and/or light intensity of the LED lighting set 12 can be adjusted according to different usage scenarios to better suit different usage requirements.

In some more preferred embodiments, one side of the control panel 16 is provided with a charging port 161, and a protection block 162 for snap-fitting the charging port 161 is connected to an edge of the charging port 161. In a case where the portable anti-fog cosmetic mirror is not charged, the protection block 162 is snap-fitted in the charging port 161 to play the waterproof and dustproof role to avoid the charging port 161 being affected by dust, water vapor and other substances, thus causing the problem of charging failure; during charging, the protection block 162 is connected to the edge of the charging port 161 by a flexible connecting wire, avoiding loss while preventing interference with charging.

### Embodiment 3

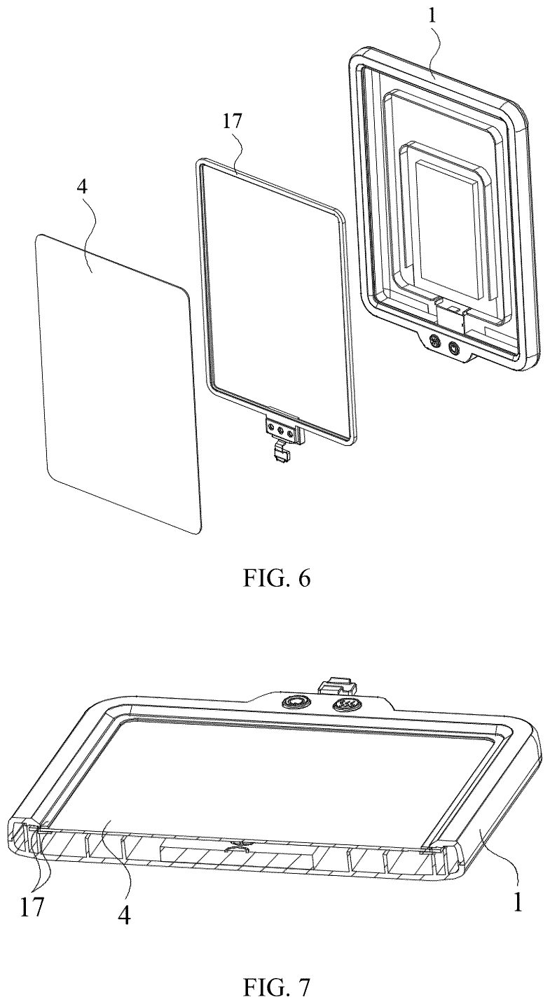

The present embodiment differs from Embodiment 2 in that the present embodiment further optimizes the structure of the portable anti-fog cosmetic mirror of the present invention, see FIGS. 6 to 9.

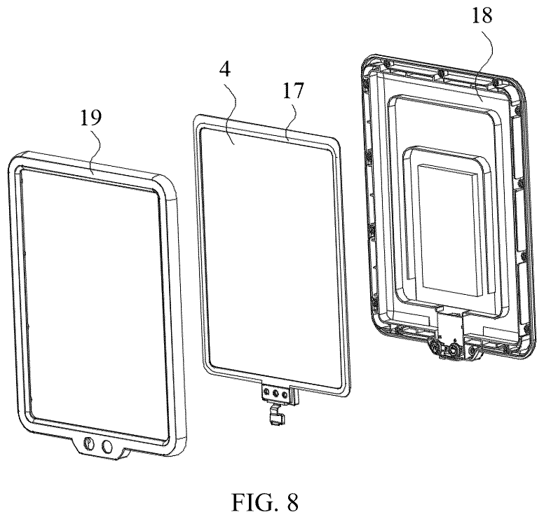

Referring to FIGS. 6 and 7, FIGS. 6 and 7 illustrate a structural relationship among the buffer 17 and the mirror frame 1 and the mirror surface 4, respectively in the embodiment of the present invention. Specifically, a buffer 17 is provided at a junction of the periphery of the mirror frame 1 and the mirror surface 4.

In the present embodiment, when the mirror surface 4 is mounted to the mirror frame 1, the mirror frame 1 and the mirror surface 4 respectively generate a pressing force on the buffer 17, so that the connection between the mirror frame 1 and the mirror surface 4 is more tightened, thereby improving the overall structural stability, and avoiding the problem that the mirror surface 4 is dropped from the mirror frame 1 and cannot be used. At the same time, the buffer 17 also plays a buffering role to protect the mirror surface 4 and prevent the mirror surface 4 from being cracked or the like. Preferably, the buffer 17 completely covers the periphery of the mirror surface 4, so that the buffering effect and the fastening effect are superior.

In some preferred embodiments, referring to FIG. 8, FIG. 8 illustrates a structural relationship among the buffers 17 and the base frame 18 and the annular fixing frame 19, respectively in an embodiment of the present invention. Specifically, the mirror frame 1 includes a base frame 18 and an annular fixing frame 19 respectively connected to the periphery of the base frame 18, and a face of the buffer 17 facing away from the base frame 18 to fix the buffer 17 to the base frame 18. The annular fixing frame 19 fixes the buffer 17 to the base frame 18 so that the mirror surface 4 is fixed in the base frame 18, thereby improving the overall compactness and further ensuring the overall structural reliability.

Further, the annular fixing frame 19 is screwed to the periphery of the base frame 18 by means of bolts to facilitate the mounting and/or removal of components inside the mirror frame 1, such as the mirror surface 4, the heating sheet 21 and the temperature sensing device 3 to improve the mounting and maintenance efficiency. It is to be understood that the annular fixing frame 19 may be attached to the periphery of the base frame 18 by means of snap-fit and scarf or the like.

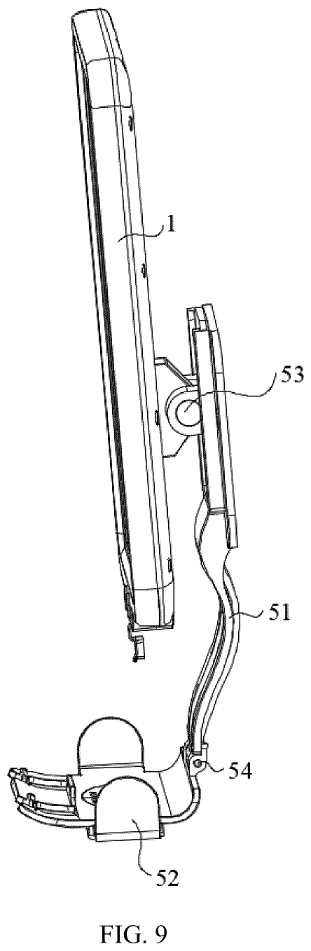

In some more preferred embodiments, referring to FIG. 9, FIG. 9 illustrates a structural relationship between the bracket assembly 5 and the mirror frame 1 in an embodiment of the present invention. Specifically, the portable anti-fog cosmetic mirror further includes a bracket assembly 5 and a support 52, where the bracket assembly 5 includes a connector 51 having one end connected to one side of the mirror frame 1 facing away from the heating sheet 21 via a first pivot 53 and the other end connected to the support 52 via a second pivot 54. The support 52 enables the mirror frame 1 to stand on a plane such as a desktop to enable the portable anti-fog cosmetic mirror to stand on a plane such as a desktop, and rotates the connector 51 and/or the mirror frame 1 to rotate the first pivot 53 and/or the second pivot 54 to adjust a rotation angle of the connector 51 and the mirror frame 1, thereby adjusting a placement angle of the portable anti-fog cosmetic mirror, which is more convenient to use.

Further, the connector 51 is telescopically connected between the mirror frame 1 and the support 52, and pushes the mirror frame 1 and/or the support 52, so that the mirror frame 1 abuts against the support 52, and is more convenient to be received and carried.

### Embodiment 4

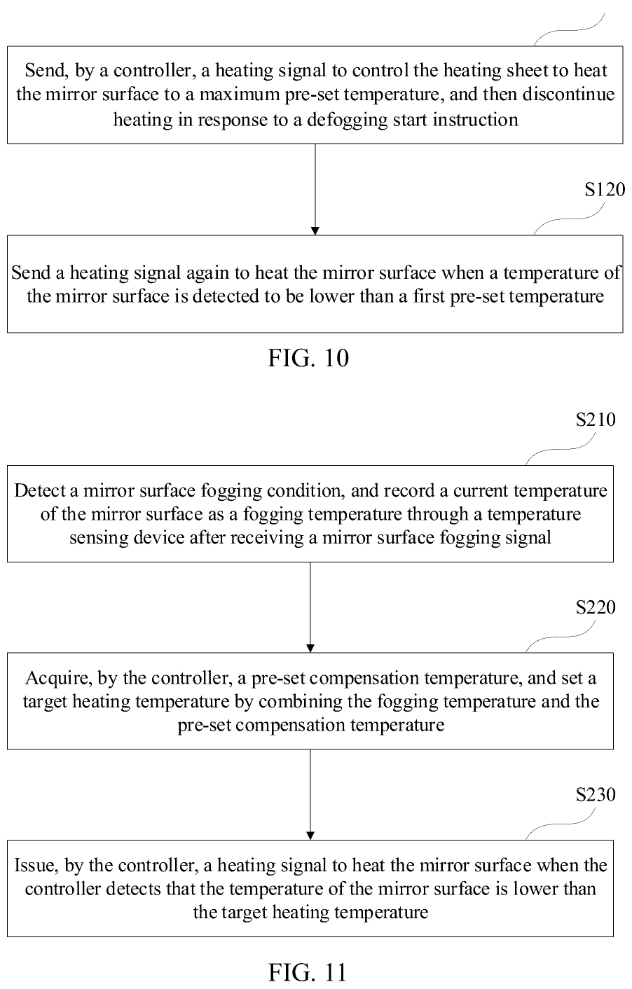

FIG. 10 shows a flowchart of an embodiment of an anti-fog method for a portable anti-fog cosmetic mirror according to the present invention. As shown in FIG. 10, based on the portable anti-fog cosmetic mirror, the method includes the steps of:
S110 Send, by a controller, a heating signal to control the heating sheet to heat the mirror surface to a maximum pre-set temperature, and then discontinue heating in response to a defogging start instruction.

When a mirror surface fogging occurs, a user triggers an defogging function; after receiving an instruction of the defogging function, a controller sends a heating signal to a heating sheet to control the heating sheet to emit heat energy; when a temperature sensing device senses that the mirror surface has reached a pre-set maximum temperature, the temperature sensing device automatically feeds back a heating discontinuing signal to the controller; and after receiving a heating discontinuing instruction, the controller transmits the instruction to the heating sheet to control the heating sheet to discontinue heating; thus, the fog generated by the mirror surface is eliminated to make the mirror surface clearer.

Of course, it is also possible to manually trigger the heating discontinuing function, and after receiving a heating function discontinuing instruction, the controller transmits a heating discontinuing signal to the heating sheet to control the heating sheet to discontinue heating to achieve an effect of energy saving.

In other embodiments, when the temperature sensing device senses that the temperature of the mirror surface is lower than a pre-set minimum temperature, a heating signal is automatically fed back to the controller, and after receiving a heating instruction, the controller transmits the heating signal to the heating sheet to control the heating sheet to emit thermal energy.

S120 Send a heating signal again to heat the mirror surface when a temperature of the mirror surface is detected to be lower than a first pre-set temperature.

When the temperature sensing device senses that the temperature of the mirror surface is lower than a first pre-set temperature, a heating signal is fed back to the controller, and after receiving a heating instruction, the controller transmits the heating signal to the heating sheet to control the heating sheet to emit thermal energy and save energy consumption while defogging.

Preferably, the maximum pre-set temperature is between 35° C. and 38° C. and the first pre-set temperature is between 31° C. and 34° C.

In some embodiments, the maximum pre-set temperature is 35° C., the first pre-set temperature is 32° C., and when the temperature of the mirror surface reaches 35° C., the heating sheet discontinues heating, and when the temperature reaches 32° C. after the mirror surface gradually cools down, the controller controls the heating sheet to heat again. It can be understood that the maximum pre-set temperature and the first pre-set temperature are related to energy consumption, and the greater the temperature value of the maximum pre-set temperature, the higher the energy consumption required for heating; therefore, by setting the first pre-set temperature, the temperature difference between the temperature of the mirror surface and the maximum pre-set temperature is within a controllable range, and the heating sheet in this temperature range controls heating to achieve the purpose of saving energy consumption.

In step S110, in addition to the sending, by the controller, the heating signal to control the heating sheet to heat the mirror surface to the maximum pre-set temperature, the method further includes:
an actual temperature of the mirror surface is collected;
a temperature difference between the actual temperature and the maximum pre-set temperature is calculated; and
the heating signal is adjusted according to the temperature difference to control the heating sheet to heat the mirror surface.

In some embodiments, the actual temperature of the mirror surface is collected by the temperature sensing device and fed back to the controller, and the controller calculates the temperature difference between the actual temperature and the maximum pre-set temperature, and adjusts the heating signal according to the obtained temperature difference, thereby controlling the heating sheet to heat the mirror surface. Preferably, the heating signal is a heating power. It will be appreciated that in some embodiments, the heating power may be set to adjust the defogging speed in order to provide a better defogging experience without increasing energy consumption. For example, when the temperature difference is large, the heating power can be increased, and when the temperature difference is small, the heating power can be decreased, and thus adjusting the heating power according to the temperature difference can achieve a defogging effect with minimum energy consumption, saving energy consumption, and thus extending the service life of the portable anti-fog cosmetic mirror.

Still further, the heating signal can control the power level of heating by controlling the current and voltage, and can also control the conduction frequency and duration of the heater in a manner similar to the PWM signal, thereby achieving the control of the total amount of heating per unit time.

Referring to FIG. 11, FIG. 11 shows a flow chart illustrating a step after the step 110 of the anti-fog method for a portable anti-fog cosmetic mirror according to the present invention.

In step S110, after the sending, by the controller, the heating signal to control the heating sheet to heat the mirror surface to the maximum pre-set temperature, and then discontinue heating, the method further includes:
S210 Detect a mirror surface fogging condition, and record a current temperature of the mirror surface as a fogging temperature through a temperature sensing device after receiving a mirror surface fogging signal.

After the controller discontinues heating, the fog condition of the mirror surface is continuously detected, and when the fog of the mirror surface is detected, the controller transmits a fogging signal to the temperature sensing device, and after receiving the fogging signal, the temperature sensing device acquires the current temperature and records the temperature as the fogging temperature. It can be understood that the means for detecting the fogging condition can be in various ways, for example, judging the condensation condition of the mirror surface by means of a humidity sensor, determining the fogging condition finally by providing an image acquisition device on the back of the mirror surface, judging the parameters of the acquired image blur and contrast, etc. Of course, in some scenarios requiring low power consumption, such as a portable scenario powered by a battery, it is necessary to improve the endurance, and a human operation can also be collected by setting a trigger button, etc. to minimize the additional power consumption generated by the system due to the need to provide a sensing device, for example, when mirror surface fogging occurs, a user sends a fogging signal through an operation, and after receiving an instruction of an defogging function, a controller determines that the mirror surface fogging occurs, and at the same time transmits the fogging signal to a temperature sensing device to record the fogging temperature. In this way, it is possible to accurately judge the fogging state of the mirror surface in different temperature environments and humidity environments.

S220 Acquire, by the controller, a pre-set compensation temperature, and set a target heating temperature by combining the fogging temperature and the pre-set compensation temperature.

After detecting another mirror surface fogging and/or receiving a defogging instruction again, the controller acquires a pre-set compensation temperature, combines the fogging temperature recorded by the temperature sensing device to obtain a target heating temperature, and controls the heating sheet to discontinue heating after heating to the target heating temperature to defog.

S230 Issue, by the controller, a heating signal to heat the mirror surface when the controller detects that the temperature of the mirror surface is lower than the target heating temperature.

When the temperature sensing device senses that the temperature of the mirror surface is lower than a target heating temperature, a heating signal is fed back to the controller, and after receiving a heating instruction, the controller transmits the heating signal to the heating sheet to control the heating sheet to emit thermal energy and save energy consumption while defogging.

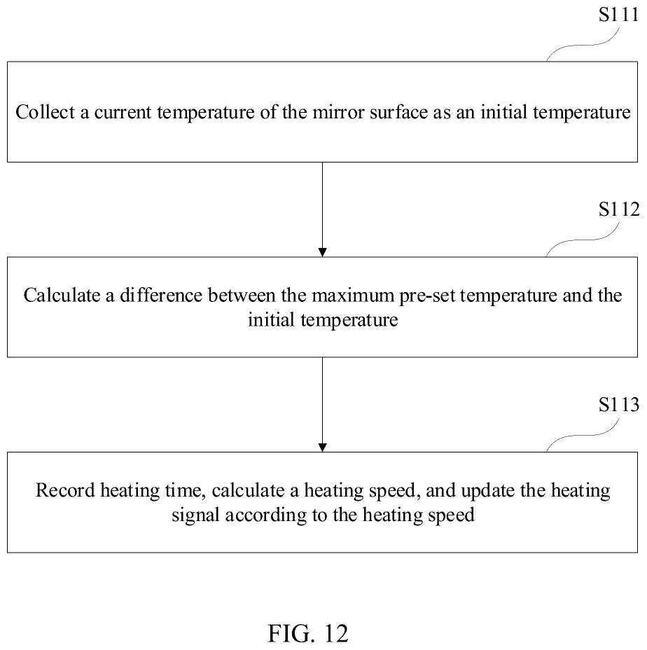

Referring to FIG. 12, FIG. 12 shows a schematic flow diagram of sub-steps in step 110 of the anti-fog method for a portable anti-fog cosmetic mirror according to the present invention.

In step S110, in addition to the sending, by the controller, the heating signal to control heating the mirror surface to the maximum pre-set temperature, the method further includes the following sub-steps:
S111: a current temperature of a mirror surface is collected as an initial temperature;
S112: a difference between the maximum pre-set temperature and the initial temperature is calculated; and
S113: the heating time is recorded, the heating speed is calculated, and the heating signal is updated according to the heating speed.

In some embodiments, the temperature sensing device collects a current temperature of the mirror surface and feeds the temperature back to the controller, the controller marks the temperature as an initial temperature of the mirror surface, records a heating time from the initial temperature to the maximum temperature by calculating a difference between the maximum pre-set temperature and the initial temperature, obtains a heating speed, and updates the heating signal according to the heating speed. It can be understood that when the temperature sensing device senses that the mirror surface is heated to a pre-set maximum temperature, the ambient temperature condition of the cosmetic mirror can be acquired through the heating speed; for example, when the heating speed is slow, it can be seen that the ambient temperature is lower, and when the heating speed is fast, the ambient temperature is higher; and if the heating speed is slow according to the pre-set heating power, the speed equivalent to the secondary defogging speed of the mirror surface is also slow, and therefore the heating power needs to be updated according to the heating speed.

In some preferred embodiments, the heating signal includes heating power; and the heating power is inversely related to the heating speed. It will be appreciated that the slower the heating speed, the greater the heating power required to achieve a rapid defogging effect.

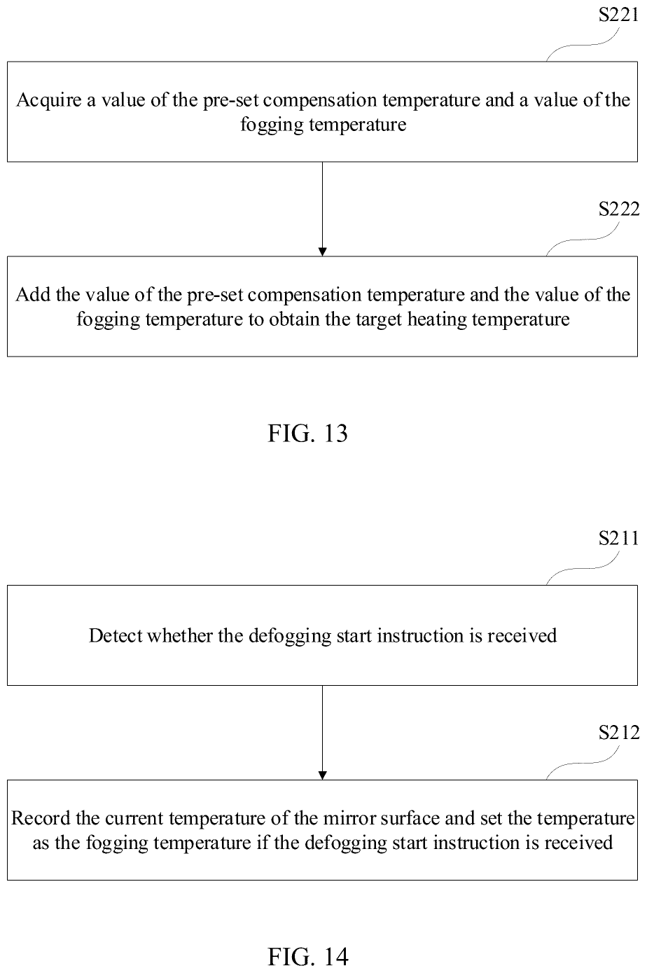

Referring to FIG. 13, FIG. 13 shows a schematic flow diagram of sub-steps in step 220 of the anti-fog method for a portable anti-fog cosmetic mirror according to the present invention.

In step S220, the acquiring the pre-set compensation temperature, and setting the target heating temperature by combining the fogging temperature and the pre-set compensation temperature includes the following sub-steps:
S221 Acquire a value of the pre-set compensation temperature and a value of the fogging temperature; and
S222 Add the value of the pre-set compensation temperature and the value of the fogging temperature to obtain the target heating temperature.

In some embodiments, the controller adds the value of the pre-set compensation temperature and the value of the fogging temperature to obtain a target heating temperature, and transmits the target heating temperature to the heating sheet to control the heating sheet to heat, so that the temperature of the mirror surface is higher than the fogging temperature, thereby achieving the defogging effect. At the same time, it is also effective to ensure that there is still sufficient redundancy to ensure that the there is no fog on the mirror surface when the environment changes.

In some preferred embodiments, the pre-set compensation temperature is any one of 2° C. to 4° C. Defogging can be performed and energy consumption can be saved, and the defogging reliability of the portable cosmetic mirror can be improved.

In some preferred embodiments, the pre-set compensation temperature is inversely related to the heating speed. It can be understood that the slower the heating speed, the greater the temperature difference, and therefore the higher the value of the pre-set compensation temperature to achieve the effect of rapid defogging; in addition, repeated heating is avoided, resulting in a large energy consumption loss.

Referring to FIG. 14, FIG. 14 shows a schematic flow diagram of sub-steps in step 210 of the anti-fog method for a portable anti-fog cosmetic mirror according to the present invention.

In step S210, mirror surface fogging condition is detected, and the current temperature of the mirror surface is recorded as a fogging temperature after receiving a mirror surface fogging signal; and the step includes the following sub-steps:
S211 Detect whether the defogging start instruction is received; and
S212 Record the current temperature of the mirror surface and set the temperature as the fogging temperature if the defogging start instruction is received.

In some embodiments, the mirror surface fogging signal is a defogging start instruction. The controller detects whether the defogging start instruction is received, and if the defogging start instruction is received, the current temperature of the mirror surface acquired by the temperature sensor is set as a fogging temperature. It can be understood that when the heating sheet discontinues heating after heating to the maximum temperature, the mirror surface will gradually cool down due to the influence of the ambient temperature, and there will be fog in the mirror surface again due to the effect of the temperature difference, and at this time, the temperature sensing device acquires the fogging temperature and feeds back same to the controller, and the controller combines the pre-set compensation temperature and the fogging temperature to set the target heating temperature, so that the temperature of the mirror surface is higher than the fogging temperature to achieve the defogging effect. In this way, the heating sheet can defog without heating to the maximum pre-set temperature during the secondary heating, which is beneficial to saving energy consumption, and does not need to set a complicated circuit system and a sensing system, and the circuit is simple; the actual fogging temperature can be acquired according to the ambient temperature, so that the system can save energy more effectively.

In some preferred embodiments, in step S211, the detecting whether the defogging start instruction is received further includes:
continuously monitoring the temperature of the mirror surface at pre-set intervals; and
entering a sleep state to discontinue acquiring the temperature of the mirror surface and discontinuing sending the heating signal if the mirror temperature is less than an initial temperature or the continuous monitoring time exceeds a pre-set off time.

In the present embodiment, the controller continuously monitors the temperature of the mirror surface at pre-set intervals, and when it is detected that the temperature of the mirror surface value is less than the initial temperature value or the monitoring time exceeds the pre-set off time, the controller and the temperature sensing device will enter a sleep state, discontinue acquiring the temperature of the mirror surface and discontinue sending a heating signal. to reduce energy consumption in standby.

In the portable anti-fog cosmetic mirror and anti-fog method according to the present invention, by providing a temperature sensing device and a heating module inside the mirror frame, the temperature sensing device can acquire the temperature of the cosmetic mirror and feedback the temperature to a controller to control the heating sheet to emit heat energy to defog from the mirror surface; when the temperature of the cosmetic mirror reaches a pre-set maximum temperature, the heating sheet discontinues heating, and the problem of scalding of a user due to an excessively high heating temperature is avoided while defogging, and energy consumption is also saved. Thus, the problem that the portable mirror cannot automatically sense the temperature and adjust the heating temperature according to the actual situation is solved.

### Embodiment 5

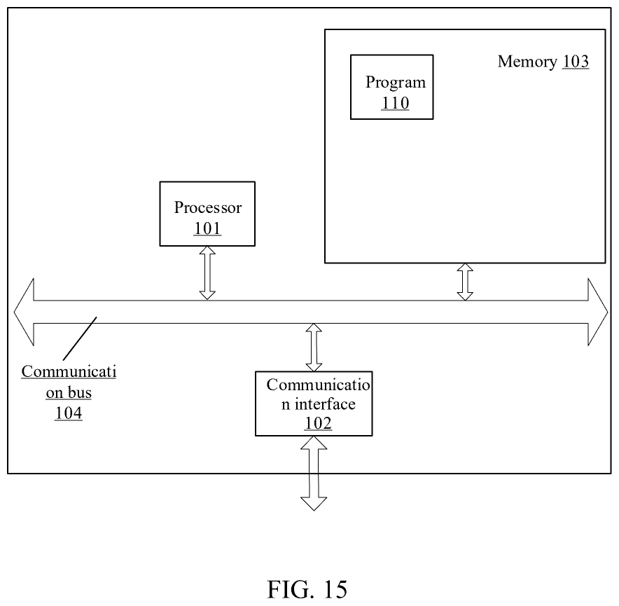

FIG. 15 shows a schematic structural diagram of an embodiment of the electronic device according to the present invention. As shown in FIG. 15, the electronic device is specifically an anti-fog device of a portable anti-fog cosmetic mirror, and may include: a processor 101, a Communications Interface 102, a memory 103, and a communication bus 104.

The processor 101, the communication interface 102, and the memory 103 communicate with each other over a communication bus 104. The communication interface 102 is used for communicating with network elements of other devices such as a network element of a client or other servers, etc. The processor 101 is used for executing the program 110 can specifically perform the relevant steps in the above-described embodiment of the anti-fog method for a portable anti-fog cosmetic mirror.

In particular, program 110 may include program code including computer-executable instructions.

Processor 101 may be a central processing unit CPU, or an Application Specific Integrated Circuit (ASIC), or one or more integrated circuits configured to implement embodiments of the present invention. The anti-fog device of the portable anti-fog cosmetic mirror includes one or more processors, which may be of the same type, such as one or more CPUs; it may also be a different type of processor, such as one or more CPUs and one or more ASICs.

The memory 103 is used for storing a program 110. The memory 103 may include high-speed RAM memory, and may also include non-volatile memory, such as at least one disk memory.

The program 110 can be specifically called by the processor 101 to make the anti-fog device of the portable anti-fog cosmetic mirror perform the following operations:
sending, by a controller, a heating signal to control the heating sheet to heat the mirror surface to a maximum pre-set temperature, and then discontinuing heating in response to a defogging start instruction; and
sending a heating signal again to heat the mirror surface when a temperature of the mirror surface is detected to be lower than a first pre-set temperature.

The above device realizes the anti-fog method for a portable anti-fog cosmetic mirror, and can solve the problem that the portable mirror cannot automatically sense the temperature and adjust the heating temperature according to the real-time air temperature.

While the present invention has been described in conjunction with the specific embodiments set forth above, it is evident that many alternatives, modifications, and variations will be apparent to a person skilled in the art in light of the foregoing description. Accordingly, it is intended to embrace all such alternatives, modifications, and variations that fall within the spirit and scope of the appended claims.

What is claimed is:

1. A portable anti-fog cosmetic mirror, comprising:
a mirror frame;
a heating module mounted on one side of a mirror surface adjacent to the mirror frame, including a heating sheet and a controller;
a temperature sensing device connected to one side of the heating sheet adjacent to the mirror frame and configured to sense an actual temperature of the heating sheet; and
a mirror surface connected to a periphery of the mirror frame.

2. The portable anti-fog cosmetic mirror according to claim 1, wherein the heating sheet is provided with several heating regions.

3. The portable anti-fog cosmetic mirror according to claim 1, wherein a surface of the heating sheet is provided with several heating wires, the several heating wires forming a heating surface by meandering, a spacing distance among the several heating wires is any value between 0.5 mm and 10 mm, and the width of the heating wire is any value between 0.5 mm and 10 mm.

4. The portable anti-fog cosmetic mirror according to claim 1, wherein the temperature sensing device is a temperature sensor.

5. The portable anti-fog cosmetic mirror according to claim 1, wherein a placement region is formed inside the mirror frame, and a mounting region for mounting an LED lighting set is formed between the periphery of the mirror frame and the placement region.

6. The portable anti-fog cosmetic mirror according to claim 5, wherein a control panel for mounting a temperature control switch and a lighting set switch extends from an edge of the mirror frame.

7. The portable anti-fog cosmetic mirror according to claim 6, wherein one side of the control panel is provided with a charging port, and a protection block for snap-fitting the charging port is connected to an edge of the charging port.

8. The portable anti-fog cosmetic mirror according to claim 1, wherein a buffer is provided at a junction of the periphery of the mirror frame and the mirror surface.

9. The portable anti-fog cosmetic mirror according to claim 8, wherein the mirror frame comprises a base frame and an annular fixing frame respectively connected to a periphery of the base frame, and one side of the buffer facing away from the base frame to fix the buffer to the base frame.

10. The portable anti-fog cosmetic mirror according to claim 1, further comprising a bracket assembly comprising a connector and a support, the connector having one end connected to one side of the mirror frame facing away from the heating sheet by a first pivot and another end connected to the support by a second pivot.

11. An anti-fog method for a portable cosmetic mirror, wherein based on the portable anti-fog cosmetic mirror according to claim 1, the method comprises:
sending, by a controller, a heating signal to control the heating sheet to heat the mirror surface to a maximum pre-set temperature, and then discontinuing heating in response to a defogging start instruction; and
sending a heating signal again to heat the mirror surface when a temperature of the mirror surface is detected to be lower than a first pre-set temperature.

12. The anti-fog method for a portable cosmetic mirror according to claim 11, wherein in addition to the sending, by the controller, the heating signal to control the heating sheet to heat the mirror surface to the maximum pre-set temperature, the method further comprises:
collecting an actual temperature of the mirror surface;
calculating a temperature difference between the actual temperature and the maximum pre-set temperature; and
adjusting the heating signal according to the temperature difference to control the heating sheet to heat the mirror surface.

13. The anti-fog method for a portable cosmetic mirror according to claim 11, wherein after the sending, by the controller, the heating signal to control the heating sheet to heat the mirror surface to the maximum pre-set temperature, and then discontinuing heating, the method further comprises:
detecting a mirror surface fogging condition, and recording a current temperature of the mirror surface as a fogging temperature through a temperature sensing device after receiving a mirror surface fogging signal;
acquiring, by the controller, a pre-set compensation temperature, and setting a target heating temperature by combining the fogging temperature and the pre-set compensation temperature;
issuing, by the controller, a heating signal to heat the mirror surface when the controller detects that the temperature of the mirror surface is lower than the target heating temperature.

14. The anti-fog method for a portable cosmetic mirror according to claim 13, wherein in addition to the sending, by the controller, the heating signal to control the heating sheet to heat the mirror surface to the maximum pre-set temperature, the method further comprises:
collecting a current temperature of the mirror surface as an initial temperature;
calculating a difference between the maximum pre-set temperature and the initial temperature; and
recording heating time, calculating a heating speed, and updating the heating signal according to the heating speed.

15. The anti-fog method for a portable cosmetic mirror according to claim 12, wherein the heating signal comprises heating power; the heating power is positively related to the temperature difference and the heating power is inversely related to the heating speed.

16. The anti-fog method for a portable cosmetic mirror according to claim 13, wherein the acquiring the pre-set compensation temperature, and setting the target heating temperature by combining the fogging temperature and the pre-set compensation temperature comprises the following sub-steps:
acquiring a value of the pre-set compensation temperature and a value of the fogging temperature; and
adding the value of the pre-set compensation temperature and the value of the fogging temperature to obtain the target heating temperature.

17. The anti-fog method for a portable cosmetic mirror according to claim 13, wherein the pre-set compensation temperature is any one of 2° C. to 4° C.

18. The anti-fog method for a portable cosmetic mirror according to claim 14, wherein the pre-set compensation temperature is inversely related to the heating speed.

19. The anti-fog method for a portable cosmetic mirror according to claim 13, wherein the mirror surface fogging signal is a defogging start instruction; the detecting the mirror surface fogging condition, and recording the current temperature of the mirror surface as the fogging temperature after receiving the mirror surface fogging signal comprises the following sub-steps:
detecting whether the defogging start instruction is received; and
recording the current temperature of the mirror surface and setting the temperature as the fogging temperature if the defogging start instruction is received.

20. The anti-fog method for a portable cosmetic mirror according to claim 19, wherein the detecting whether the defogging start instruction is received further comprises:
continuously monitoring the temperature of the mirror surface at pre-set intervals; and
entering a sleep state to discontinue acquiring the temperature of the mirror surface and discontinuing sending the heating signal if the mirror temperature is less than an initial temperature or the continuous monitoring time exceeds a pre-set off time.
